(19) United States
(12) Patent Application Publication
(10) Pub. No.: US 2013/0035997 A1
(43) Pub. Date: Feb. 7, 2013

(54) MANAGING INCENTIVES

(71) Applicants: Russell I. Hanson, Salem, UT (US); Ryan Remkes, Salem, UT (US); Michael T. Merrill, Salem, UT (US); Kory Tanner, Salem, UT (US)

(72) Inventors: Russell I. Hanson, Salem, UT (US); Ryan Remkes, Salem, UT (US); Michael T. Merrill, Salem, UT (US); Kory Tanner, Salem, UT (US)

(73) Assignee: ABOUT TIME TECHNOLOGIES, LLC, Payson, UT (US)

(21) Appl. No.: 13/567,256

(22) Filed: Aug. 6, 2012

Related U.S. Application Data
(60) Provisional application No. 61/515,740, filed on Aug. 5, 2011.

(51) Int. Cl. G06Q 30/02

(52) U.S. Cl. 705/14.17

(57) ABSTRACT

For managing incentives, a management module creates an incentive record that includes a milestone, a target completion time, and an incentive amount. A communication module communicates the incentive record to a recipient device and receives a confirmation from the recipient device. The communication module further receives a status from the recipient device. The management module confirms a completion of the milestone and the communication module transfers a payment in response to confirming the completion of the milestone.

### CROSS-REFERENCE TO RELATED APPLICATIONS

In This application claims priority to U.S. Provisional Patent Application No. 61/515,740 entitled “MANAGING INCENTIVES” and filed on Aug. 5, 2011 for Russell I. Hanson et al., which is incorporated herein by reference.

### FIELD

The subject matter disclosed herein relates to incentives and more particularly relates to managing incentives.

### BACKGROUND

### Description of the Related Art

Incentives are often used to motivate timely performance of tasks. Unfortunately, incentives can be difficult and expensive to manage.

### BRIEF SUMMARY

A method is disclosed for managing incentives. A management module creates an incentive record that includes a milestone, a target completion time, and an incentive amount. A communication module communicates the incentive record to a recipient device and receives a confirmation from the recipient device. The communication module further receives a status from the recipient device. The management module confirms a completion of the milestone and the communication module transfers a payment in response to confirming the completion of the milestone.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an incentive management system;

FIG. 2 is a schematic block diagram illustrating one alternate embodiment of an incentive management system;

FIG. 3 is a schematic block diagram illustrating one alternate embodiment of an incentive management system;

FIG. 4 is a schematic block diagram illustrating one embodiment of an incentive record;

FIG. 5 is a schematic block diagram illustrating one embodiment of a data processing device;

FIG. 6 is a schematic block diagram illustrating one embodiment of an incentive apparatus; and

FIG. 7 is a schematic flow chart diagram illustrating one embodiment of an incentive management method.

### DETAILED DESCRIPTION

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer-readable medium(s) having computer-readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer-readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer-readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer-readable program code may be stored and/or propagated on in one or more computer-readable medium(s).

The computer-readable medium may be a tangible computer-readable storage medium storing the computer-readable program code. The computer-readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer-readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer-readable storage medium may be any tangible medium that can contain, and/or store computer-readable program code for use by and/or in connection with an instruction execution system, apparatus, or device.

The computer-readable medium may also be a computer-readable signal medium. A computer-readable signal medium may include a propagated data signal with computer-readable program code embodied therein, for example, in baseband or as part of a carrier wave. Such a propagated signal may take any of a variety of forms, including, but not limited to, electrical, electro-magnetic, magnetic, optical, or any suitable combination thereof. A computer-readable signal medium may be any computer-readable medium that is not a computer-readable storage medium and that can communicate, propagate, or transport computer-readable program code for use by or in connection with an instruction execution system, apparatus, or device. Computer-readable program code embodied on a computer-readable signal medium may be transmitted using any appropriate medium, including but not limited to wireline, optical fiber, Radio Frequency (RF), or the like, or any suitable combination of the foregoing

In one embodiment, the computer-readable medium may comprise a combination of one or more computer-readable storage mediums and one or more computer-readable signal mediums. For example, computer-readable program code may be both propagated as an electro-magnetic signal through a fiber optic cable for execution by a processor and stored on RAM storage device for execution by the processor.

Computer-readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer-readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider. In another embodiment, the service provider requests payment directly from a customer account at a banking or financial institution.

In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer-readable program code. The computer-readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer-readable program code may also be stored in a computer-readable medium that can direct a computer, other programmable data processing apparatus, or other devices to function in a particular manner, such that the instructions stored in the computer-readable medium produce an article of manufacture including instructions which implement the function/act specified in the schematic flowchart diagrams and/or schematic block diagrams block or blocks.

The computer-readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer-readable program code.

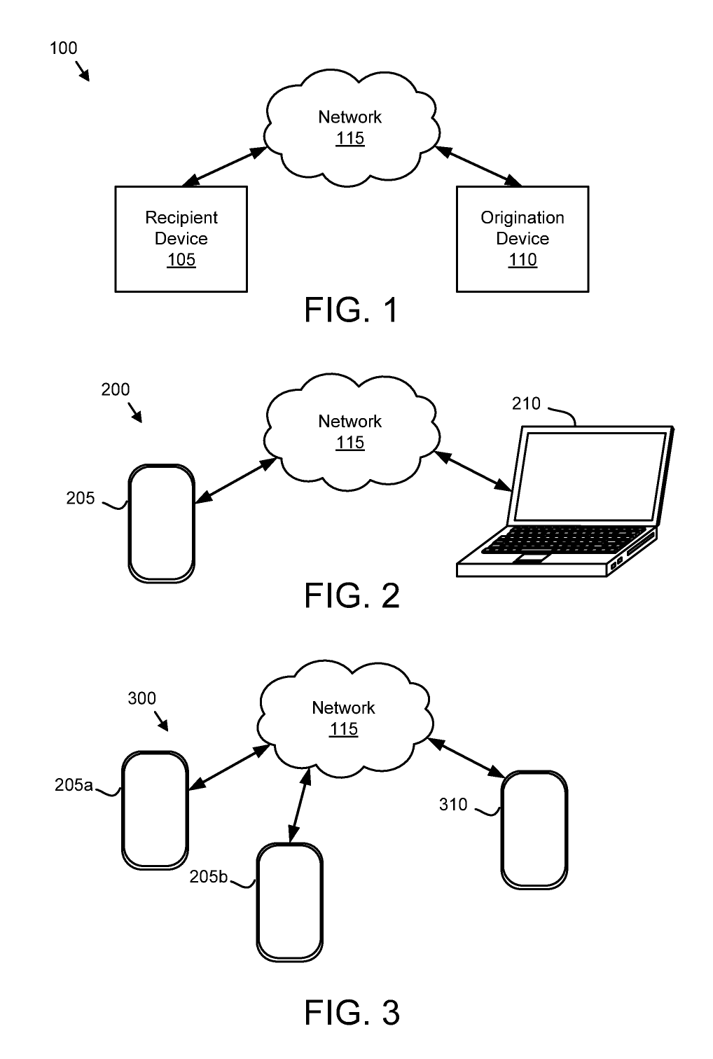

FIG. 1 is a schematic block diagram illustrating one embodiment of an incentive management system 100. The system 100 includes a recipient device 105, an origination device 110, and a network 115. The recipient device 105 and the origination device 110 may each be one of a computer workstation, a tablet computer, a laptop computer, a cellular telephone, a smart cellular telephone, a personal digital assistant (PDA), or the like. The network 115 may be the Internet, a public wide area network (WAN), a private WAN, a public local area network (LAN), a private LAN, a cellular telephone network, a peer-to-peer network, or the like.

In one embodiment, a communication with the recipient device 105 is through e-mail. Alternatively, communication with the recipient device 105 may be through Short Message Service (SMS) text messages. In a certain embodiment, communication with the recipient device 105 is through a mobile application such as a smart cellular telephone application. In an alternate embodiment, communication with the recipient device 105 is through a web page.

In one embodiment, the origination device 110 may create an incentive record and communicate the incentive record to the recipient device 105 through the network 115. An originator may use the origination device 110 to create the incentive record. The incentive record may describe a task. The task may be directed to a recipient. The task may be included in the scope of the recipient's duties. For example, the recipient may be employed directly and/or indirectly by the originator and/or an organization of the originator. Alternatively the recipient may be an independent contractor. In one embodiment, the recipient is an individual that the originator wishes to incent, but the recipient has no formal employment and/or contract relationship with the originator. For example, the originator may be a parent and the recipient may be a child. The recipient may request the task.

FIG. 2 is a schematic block diagram illustrating one alternate embodiment of an incentive management system 200. The system 100 of FIG. 1 is shown with the recipient device depicted as a smart cellular telephone 205 and the origination device 110 depicted as a laptop computer 210. One of skill in the art will recognize that embodiments may be practiced by employing other devices as the recipient device 105 and/or the origination device 110.

FIG. 3 is a schematic block diagram illustrating one alternate embodiment of an incentive management system 300. The system 100 of claim 1 is shown with the recipient device 105 depicted as a plurality of smart cellular telephones 205 and the origination device 110 depicted as a smart cellular telephone 310. One of skill in the art will recognize that embodiments may be practiced by employing other devices as the recipient device 105 and/or the origination device 110.

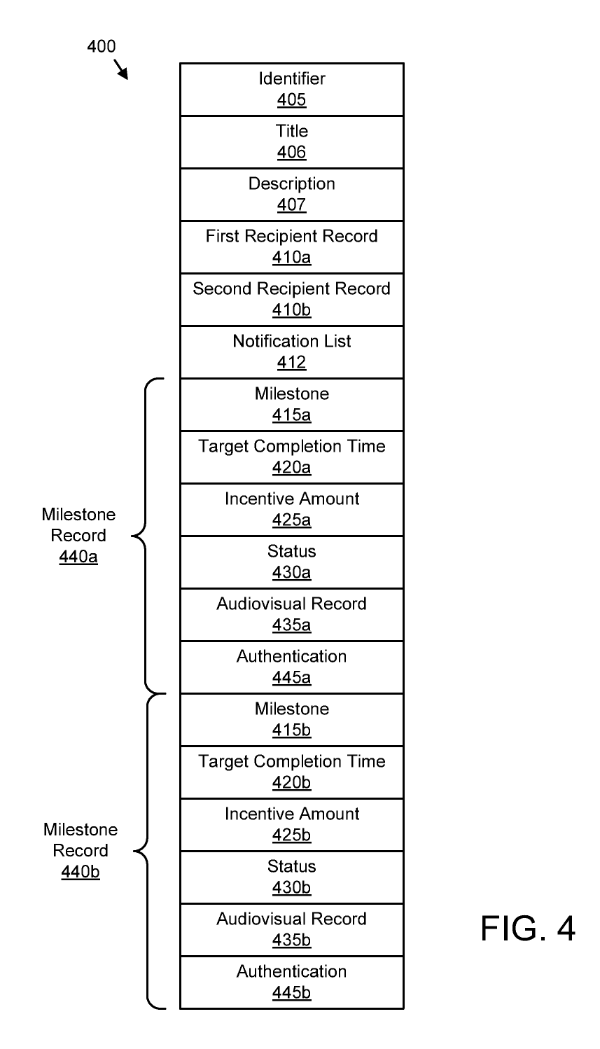

FIG. 4 is a schematic block diagram illustrating one embodiment of an incentive record 400. The incentive record 400 may be the incentive record communicated between the origination device 110 and a recipient device 105. The description of the incentive record 400 refers to elements of FIGS. 1-3, like numbers referring to like elements. The incentive record 400 includes an identifier 405, a title 406, a description 407, one or more recipient records 410, a notification list 412, and one or more milestone records 440. In one embodiment, each milestone record 440 includes a milestone 415, a target completion time 420, an incentive amount 425, a status 430, an audiovisual record 435, and an authentication 445.

The identifier 405 may identify the incentive record 400. In one embodiment, the identifier 405 includes a time stamp, an identification of the origination device 110, an identification of the originator, an organizational identifier, an address, a telephone number, and a security code. In a certain embodiment, the identifier 405 is a hash of the time stamp, the identification of the origination device 110, the identification of the originator, the organizational identifier, and/or a security code.

The title 406 may be a text title that labels the incentive record 400 for the originator and/or the recipient. The title 406 may include a subject.

The description 407 may describe the task. In one embodiment, the description 407 includes a location. The location may be a street address, directions, and/or global positioning system (GPS) coordinates. The description 407 may further include instructions. In one embodiment, the instructions may be step-by-step instructions for completing the task. In addition, the instructions may include audio notes, video notes, images, and the like that identify and/or describe the task.

The recipient records 410 may identify one or more recipients of the incentive record 400. In one embodiment, each recipient identified by the recipient records 410 is incented to complete the task. The recipient records 410 may include a name of each recipient, one or more recipient device electronic addresses, a financial account number, a physical address, and the like. The recipient device electronic addresses may be Internet Protocol addresses, Universal Resource Locator (URL) addresses, cellular telephone numbers, e-mail addresses, and the like. In one embodiment each recipient record 410 includes a share value indicating the portion of the incentive that the recipient of the recipient record 410 is to receive.

The notification list 412 may identify one or more support personnel and/or data processing device (DPD) used by the support personnel. The support personnel may be people that are not performing the task, but that should be notified of the task. In one embodiment, the notification list 412 includes one or more roles for each support personnel. Roles may include notification, enabling, and authentication. Support personnel with a notification role may have a need to be apprised of the task. In one embodiment, and support personnel with an enabling role provide assistance to the recipients in performing a task. For example, support personnel with the enabling role may provide access to a job site, materials, documentation, and the like to the recipients. In one embodiment, the notification list 412 details the support provided by support personnel with the enabling role.

In one embodiment, support personnel of the authentication role are assigned to verify the completion of the task. For example, a job site foreman may be assigned the authentication role. In the authentication role, the foreman may verify the completion of the task.

The milestone 415 may specify a quantifiable portion of the task. Alternatively, the milestone 415 may specify the whole task. In one embodiment, the milestone 415 includes a checklist of required items that must be completed for the quantifiable portion of the task or whole task to be complete. In one embodiment, each checklist item includes a weight. The weight may indicate a portion of the milestone 415 attributed to the checklist item. In addition, the milestone 415 may include procedures for verifying that the quantifiable portion of the task or whole task is complete.

The target completion time 420 may specify a date and/or time that the milestone 415 is scheduled to be completed. The incentive amount 425 may specify an amount of monetary compensation that will be paid upon completion of the task. In one embodiment, the target completion time 420 comprises a plurality of dates and/or times and the incentive amount 425 comprises a plurality of amounts, with an amount corresponding to each date/time. For example, a first date may correspond to a higher amount of monetary compensation while a later second date may correspond to a lower amount of monetary compensation. Thus the milestone record 440 may incent the recipient to complete the milestone 415 earlier rather than later in order to be eligible for the higher amount of monetary compensation.

The status 430 specifies the status of completion of the milestone 415. In one embodiment, the status 430 indicates if the milestone 415 is complete or not complete. Alternatively, the status 430 may comprise a completion estimate expressed as a percentage or ratio. For example, the status 430 may indicate that the milestone 415 is 80% complete. In one embodiment, the status 430 is calculated from the weights of each completed checklist item.

The authentication 445 may indicate that the milestone 415 is complete. In one embodiment, the authentication 445 is a secure user identification and password. For example, the recipient may enter the secure user identification and password on the recipient device 105 to authenticate that the milestone 415 is complete. Alternatively, the recipient device 105 may capture an image such as a picture of the job site as the authentication 445.

In one embodiment, the recipient device 105 may capture a signature as the authentication 445. The signature may be entered by the recipient. Alternatively, the signature may be entered by support personnel such as a foreman, supervisor, and the like. In one embodiment, the authentication is a biometric value. For example, the recipient may record a biometric value such as a thumbprint, a fingerprint, a voice pattern, a retinal scan, or the like as the authentication 445. Alternatively, support personnel may enter the biometric value. In one embodiment, the biometric value is verification that the milestone 415 is complete.

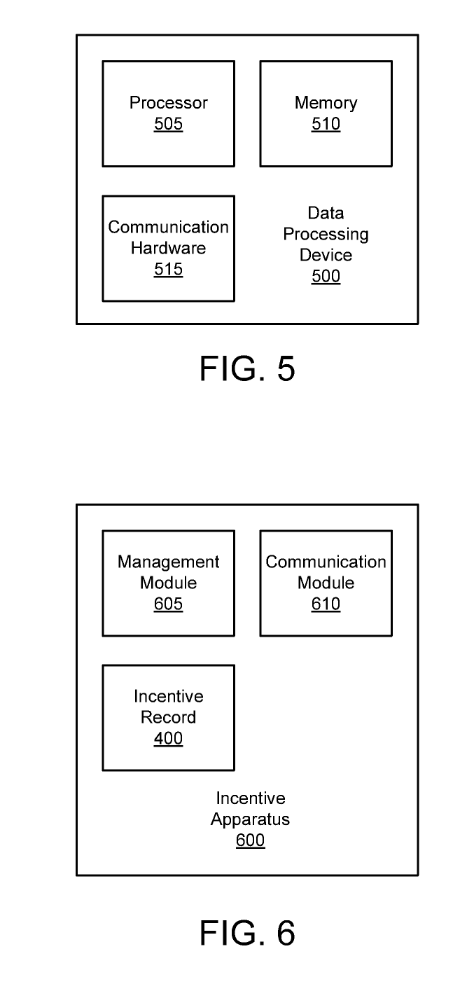

FIG. 5 is a schematic block diagram illustrating one alternate embodiment of a DPD 500. The DPD 500 may be the recipient device 105 and/or origination device 110 of FIG. 1. The DPD 500 includes a processor 505, a memory 510, and communication hardware 515. The memory 510 may be a computer-readable storage medium. The memory 515 may store a computer-readable program. The processor 505 may execute the computer-readable program. The DPD 500 may communicate with other devices through the communication hardware 515. In one embodiment, the memory 410 stores the incentive record 400. The memory 410 may be a semiconductor memory, hard disk drive, optical storage device, or combinations thereof.

FIG. 6 is a schematic block diagram illustrating one alternate embodiment of an incentive apparatus 600. The incentive apparatus 600 may be embodied in one or more DPD 500 of FIG. 5. The description of the apparatus 600 refers to elements of FIGS. 1-5, like numbers referring to like elements. In one embodiment, the apparatus 600 is embodied in the origination device 110, a server, the recipient device 105, or combinations thereof.

The apparatus 600 includes a management module 605, a communication module 610, and the incentive record 400. The management module 605, the communication module 610, and the incentive record 400 may comprise computer-readable program code stored in a computer-readable storage medium such as the memory 510 and executed by the processor 505.

The management module 605 creates the incentive record 400. The communication module 610 communicates the incentive record 400 to a recipient device 105. In addition, the communication module 610 receives a confirmation from the recipient device 105 and receives a status 430 from the recipient device 105. The management module 605 confirms a completion of the milestone 415. The communication module 610 transfers a payment in response to confirming the completion of the milestone 415.

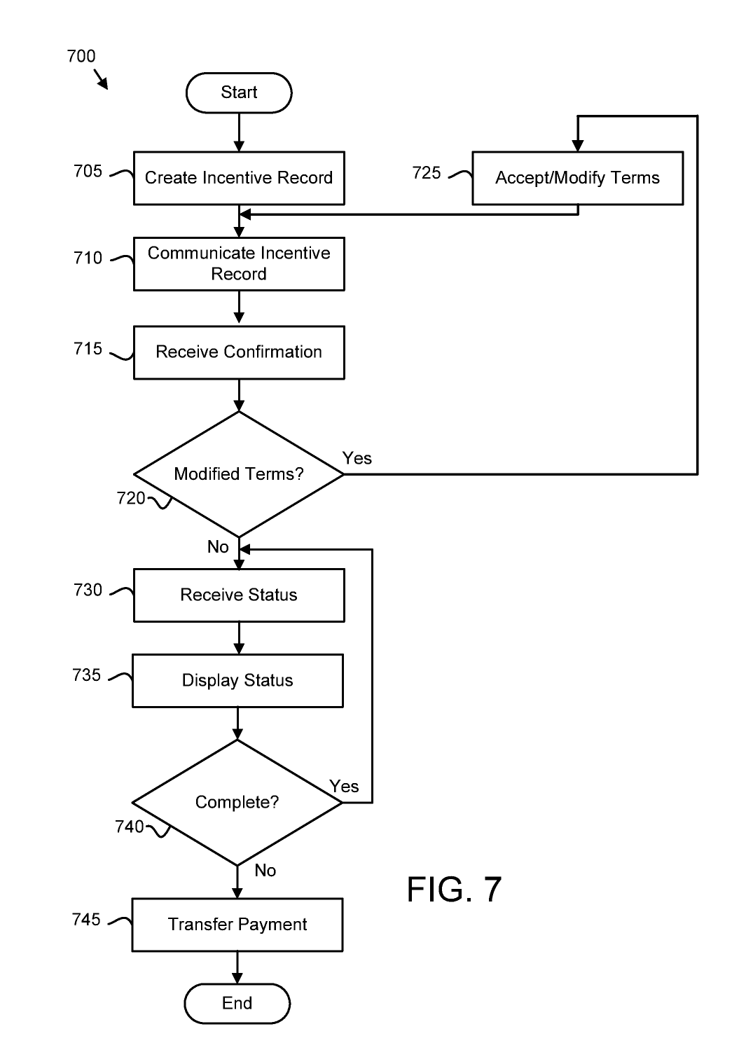

FIG. 7 is a schematic flow chart diagram illustrating one embodiment of an incentive management method 700. The method 700 may implement the functions of the apparatus 600 as described hereafter. The description of the method refers to elements of FIGS. 1-6, like numbers referring to like elements. In one embodiment, computer-readable program code that is stored on a computer-readable storage medium and executed by a processor performs the functions of the method 700

The method 700 starts, and in one embodiment, the management module 605 creates 705 an incentive record 400 comprising a milestone 415, the target completion time 420, and the incentive amount 425. The incentive record 400 may be created on the origination device 110. Alternatively, the origination device 110 may create the incentive record 400 on the server. The incentive record 400 may be stored on the server. Alternatively, the incentive record 400 may be stored on at least one of the recipient device 105 and the origination device 110. In one embodiment, a copy of the incentive record 400 is stored on the server.

The communication module 610 may communicate 710 the incentive record 400 to the recipient device 105. The communication module 610 may receive 715 a confirmation from the recipient device 105. The management module 605 may determine 720 if the confirmation modifies the terms embodied in the incentive record 400. In one embodiment, the confirmation may accept the terms embodied in the incentive record 400. Alternatively, the recipient may request to the recipient device 105 modified terms. If the management module 605 determines 720 that the confirmation modifies the terms, the management module 605 may present the modified terms to the originator through the originator device 110. The originator may accept and/or modify the terms through the originator device 110. The communication module 610 may communicate 710 the incentive record 400 with the accepted and/or modified terms to the recipient device 104 and receive 715 the confirmation.

If the last terms sent to the recipient device 105 are not modified, the communication module 610 receives 730 the status 430 from the recipient device 105. The management module 605 may display 735 the status through the originator device 110.

The management module 605 further confirms 740 that the milestone 415 is complete. If the management module 605 determines that the milestone 415 is not complete, the communication module 610 continues to receive 730 the status 430. If the management module 605 determines that the milestone 415 is complete, the communication module 610 transfers 745 a payment and the method 700 ends.

In one embodiment, the payment is transferred 745 to a destination selected from the group consisting of a debit card, a general purpose reloadable prepaid card, a non-reloadable prepaid card, a payroll card, a bank account, and a mobile telephone debit account. The payment may be transferred through the recipient device 105. In addition, the payment may be in the amount of the incentive amount 425.

In one embodiment, the payment is transferred 745 in specified portions after specified time intervals. For example, 25% of the payment may be transferred each week for four weeks. The steps of receiving status 730, displaying status 735, determining completion 740, and transferring payment 745 may be repeated for a plurality of milestones 415 until all milestones 415 in an incentive record 400 are complete.

The method 700 manages the creation, awarding, completion verification, and payment of incentives. Incentives can be quickly created, communicated, and bid, so that work on a task starts expeditiously. In addition, the method 700 provides for quick verification that the task is complete. Finally, the method 700 supports quick payment of the incentive, increasing the value and effectiveness of the incentive.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for managing incentives comprising:
creating, by use of a processor, an incentive record comprising a milestone, a target completion time, and an incentive amount;
communicating the incentive record to a recipient device;
receiving a confirmation from the recipient device;
receiving a status from the recipient device;
confirming a completion of the milestone; and
transferring a payment in response to confirming the completion of the milestone.

2. The method of claim 1, wherein communication with the recipient device is through e-mail.

3. The method of claim 1, wherein communication with the recipient device is through Short Message Service (SMS) text messages.

4. The method of claim 1, wherein communication with the recipient device through a mobile application.

5. The method of claim 1, wherein communications with the recipient are through a web page.

6. The method of claim 1, wherein the payment is transferred to a destination selected from the group consisting of a debit card, a general-purpose reloadable prepaid card, a non-reloadable prepaid card, a payroll card, a bank account, and a mobile telephone debit account.

7. The method of claim 1, wherein the confirmation comprises a modification of at least one of the milestone, the target completion time, and the incentive amount.

8. The method of claim 1, wherein the incentive record is stored on a server.

9. The method of claim 1, wherein the incentive record is stored on one of the recipient device and an originating device and a copy of the incentive record is stored on a server.

10. The method of claim 1, further comprising displaying the status.

11. The method of claim 1, wherein the status comprises an authentication selected from a secure user identification and a password, an image, a signature, and a biometric value.

12. The method of claim 1, wherein the recipient requests the incentive record.

13. An apparatus comprising:
a computer-readable storage medium storing computer-readable program code executable by a processor, the computer-readable program code comprising:
a management module creating an incentive record comprising a milestone, a target completion time, and an incentive amount;
a communication module communicating the incentive record to a recipient device, receiving a confirmation from the recipient device, and receiving a status from the recipient device;
the management module confirming a completion of the milestone; and
the communication module transferring a payment in response to confirming the completion of the milestone.

14. The apparatus of claim 13, wherein the payment is transferred to a destination selected from the group consisting of a debit card, a general-purpose reloadable prepaid card, a non-reloadable prepaid card, a payroll card, a bank account, and a mobile telephone debit account.

15. A computer program product for managing incentives, the computer program product comprising:
a computer-readable storage medium having computer-readable program code embodied therein, the computer-readable program code configured to perform the functions of:
creating an incentive record comprising a milestone, a target completion time, and an incentive amount;
communicating the incentive record to a recipient device;
receiving a confirmation from the recipient device;
receiving a status from the recipient device;
confirming a completion of the milestone; and
transferring a payment in response to confirming the completion of the milestone.

16. The computer program product of claim 15, wherein communication with the recipient device is through a channel selected from the group consisting of e-mail, Short Message Service (SMS) text messages, a mobile application, and a web page

17. The computer program product of claim 15, wherein the payment is transferred to a destination selected from the group consisting of a debit card, a general-purpose reloadable prepaid card, a non-reloadable prepaid card, a payroll card, a bank account, and a mobile telephone debit account.

18. The computer program product of claim 15, wherein the confirmation comprises a modification of at least one of the milestone, the target completion time, and the incentive amount.

19. The computer program product of claim 15, wherein the incentive record is stored on one of a server, the recipient device, and an originating device.

20. The computer program product of claim 15, wherein the status comprises an authentication selected from a secure user identification and a password, an image, a signature, and a biometric value.
